(19) United States
(12) Patent Application Publication
(10) Pub. No.: US 2006/0080602 A1
(43) Pub. Date: Apr. 13, 2006

(54) Method for downloading a structured file from a server to a terminal device, and a corresponding terminal device

(75) Inventor: Kimmo Lahdensivu, Lempaala (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/248,906

(22) Filed: Oct. 11, 2005

(30) Foreign Application Priority Data
Oct. 12, 2004 (FI) 20045384

(51) Int. Cl. G06F 17/24; G06F 15/16; G06F 17/21

(52) U.S. Cl. 715/515; 715/514; 709/203; 709/231

(57) ABSTRACT

The invention relates to a method, terminal device, program, and information structure for downloading a structured file, containing formatted text and other information, from a server to the terminal device over a telecommunications link. The user selects the file to be downloaded and initiates the downloading operation. The file is opened on the display of the terminal device. The file has a hierarchal structure, in such a way that the contents of the file are arranged in at least two information levels. The terminal device is arranged to display the first information level immediately it has been downloaded and to supplement the information shown at the downloading of the levels progresses, until the file has been downloaded and displayed in its entirety.

### FIELD OF THE INVENTION

The present invention relates to a method for downloading a structured file, containing formatted text and other information, from a server to a terminal device over a telecommunications link, in which the user selects the file to be downloaded and initiates the downloading operation, and in which the file is opened on the display of the terminal device. The invention also relates to a corresponding terminal device. The terminal device can be a mobile station equipped with suitable application programs.

### BACKGROUND OF THE INVENTION

Office documents are received as e-mail attachments from an e-mail server, downloaded from a Web server, or downloaded from a file server.

Office documents, for example, Microsoft® Word, PowerPoint, and Excel files contain not only raw text, but also formatting and style information as well as many other kinds of information. In particular, a file containing images can take an uncomfortably long time to open on a display, if only a narrow telecommunications link is available, which is usually the case with a mobile station.

As such, the same problem also concerns markup-type documents (such as HTML). HTML pages too are rendered on the display in the order in which the file's HTML tags are received. Though a text portion without formatting will be quickly displayed using an HTML file and terminal application (such as a browser) that supports it well, the calls defined by the tags will be performed in the sequence in which they appear in the document, irrespective of their order of importance, and will slow down the operation of the text's formatting. The HTML language contains no possibly whatsoever to alter their downloading sequence.

In the HTML language, an image is represented by an <IMG> tag, which gives the name and address of the image file to be retrieved to the location in question. In this way, the actual image information is separated from the body file. Like the other tags, they are performed consecutively, irrespective of their degree of importance.

Document US 2004/00644475A1 presents a method for progressive encoding and multiplexing of web pages. The method enables a receiving-side user to speedily obtain important information in tree-structured documents even if the size of the received tree structure is large. This is accomplished by setting a node priority with respect to each node of a tree-structured document. This gives inevitably benefit when handling very big documents. For small size documents the disclosed system is too heavy and there exists a demand for a corresponding system for lighter files.

A way of converting a heavy document into a light viewable version, using a special conversion program, is also known, but part of the information will then be irretrievably lost.

### SUMMARY OF THE INVENTION

The invention is intended to create a new type of method, and a terminal device using the method, for accelerating the opening of a structured file. The characteristic features of the method according to the invention are stated in the accompanying Claim 1, the characteristic features of the corresponding terminal device in Claim 5. By prioritizing the information of the file in layers, which are sent consecutively, it is possible to ensure that the most important information is always displayed before the less important information is processed.

Instead of a text document, the structured document can be a graphical presentation, a table, or some combination of these. The author of the document should mark in some suitable manner (not shown) what is most important in the document, what is next most important, and so on. By prioritizing the information in this way, the parts of the document can be placed in information layers, which are sent in order of importance.

The invention can be applied in, for instance, mobile stations and portable computers.

In the following, the invention is examined with the aid of the accompanying drawings, which show the operation and embodiments of the invention.

### BRIEF DESCRIPTION OF THE DRAWINGS

FIG. 1 shows a mobile station being used to read a file held on a server

FIG. 2 shows a layered file structure according to the invention.

### DETAILED DESCRIPTION OF THE INVENTION

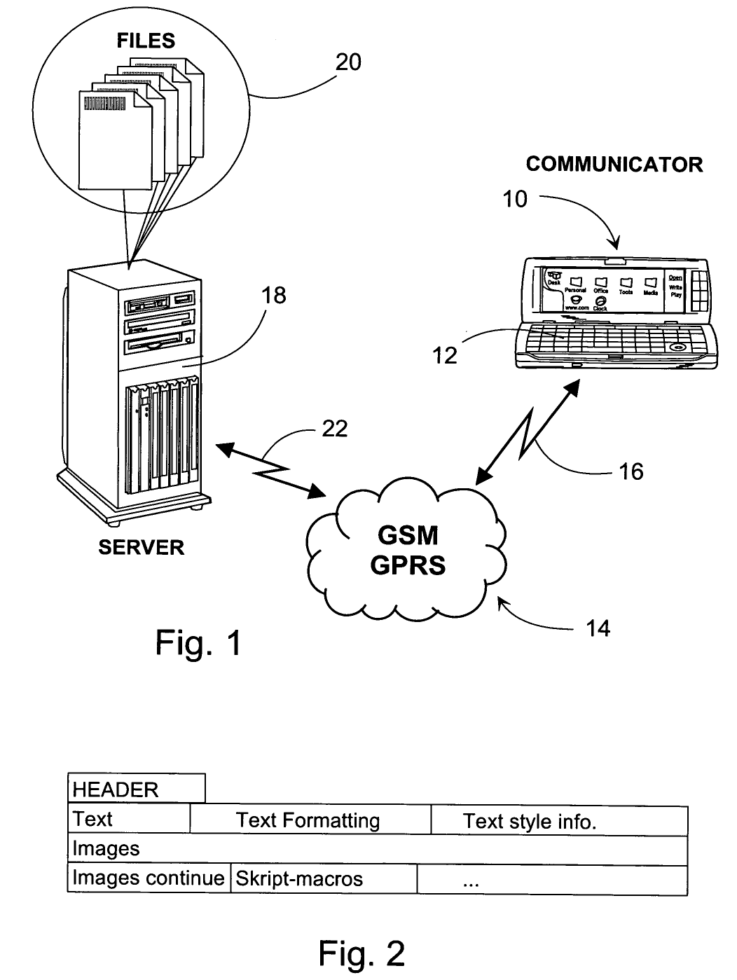

In FIG. 1, the reference number 10 indicates a mobile station, by means of which document files, which are stored on a server 18, can be downloaded and read. The mobile station 10 is equipped with a display 12 and corresponding software for receiving and viewing document files. In a known manner, the mobile station 10 is a client of a mobile network 14 over a wireless link 16. The mobile network 14 is connected to other networks over a fixed link 22, through which it is connected to the server 18. The mobile station 10 can thus be used to browse and download the files 20 held on the server 18.

The slowness of opening a file becomes apparent in connection with a terminal device using a limited band of this kind, in which the downloading of the file, i.e. of all of the information of the document, can take a considerable length of time.

At least one of the files 20 has the structure of a structured file according to the invention, in which case it contains several different kinds of information, particularly text, its formatting, style information, and images. The files are assembled by prioritizing the importance of each information portion and setting the information portions thus obtained to be downloaded in sequence. The terminal device then processes the file in real time with the aid of a suitable application program and renders the elements of the information flow directly in place.

FIG. 2 shows an example of multi-stage information, in which, for reasons of drawing technique, the boxes are collected on the same line, even though each box shows its own information layer. One example of this is an MS-Powerpoint®-type presentation file. The headings and bullets of the slides can be stored as text in the first layer, the formatting of the text in the second layer, the formulae and images in the third layer, the slide's background image in the fourth, and the animations in the last layer.

In this case, the file has a header field, which is not, however, important in terms of the present invention. It includes data on the total length of the file, the layers used, and other selected information.

In this case, the highest priority is given to the text information, after which come the formatting of the text and the sets of style information. With the aid of the raw text, the application program shows the document quite quickly. In this case, the fourth layer is entirely reserved for the document's images, which are thus downloaded and placed on the display only once the first layer has been completely downloaded.

The fifth layer contains less important images (if there are such), the sixth layer script-macros, and the seventh layer other possible information.

Each information layer is equipped with an initial identifier (not shown), by means of which the application program distinguishes the information portions from the continuous data flow and sets them in place. Alternatively, there can be precise data in the header field on the location of each part relative to the start of the file. In one application, the second and later layers include an identifier showing their relative locations.

The method can be implemented by software in the terminal device, in which the terminal device includes at least
means for receiving a file in the form of an information flow consisting of a series of characters, from a telecommunications link, the file thus including consecutive information layers each equipped with an initial identifier,
a processor and memory for processing and opening the file,
a display for showing the file,
an application program for processing the information content of the information levels.

The file is downloaded in the following stages:
receiving of the information flow of the structured file while storing the characters received in the memory in a selected area of the memory,
detecting each initial identifier from the information flow, in order to distinguish the information layers from each other and storing the corresponding information in the second selected area of the memory,
processing each stored information level in the memory separately, in such a way that its content is transferred from the memory to the display, according to the application program.

Application program has processing code for processing at least text and images for displaying and formatting of the text therein.

It is possible to define a format, i.e. a data structure, which includes a model of a structured file, in which there is both formatted text and other information. The file thus has a hierarchal structure, in such a way that the contents of the file are arranged in at least two information layers, which are placed in sequence, according to a selected criterion, in order of importance, and which are each equipped with an initial identifier, in order to distinguish the different information layers from each other.

1. Method for downloading a structured file, containing formatted text and other information, from a server to a terminal device over a telecommunications link, in which the user selects the file to be downloaded and initiates the downloading operation, and in which the file is opened on the display of the terminal device, and where the file has a hierarchal structure, in such a way that the contents of the file are arranged in at least two priorized information levels and the terminal device is arranged to display the first information level immediately it has been downloaded and to supplement the information shown at the downloading of the levels progresses, until the file has been downloaded and displayed in its entirety, characterized in that, the priorized information levels are sent sequentially in order of significance, the most significant one first, the sending order only defining the priority levels, and in the format defining the form of the file, there are prioritized levels for at least the text, the formatting of the text, and images.

2. Method according to claim 1, characterized in that the file includes a header field, which contains information on the information levels used in the file.

3. Method according to claim 1, characterized in that at the start of the information of each information level a code is selected, to distinguish the different levels from each other.

4. Method according to of claim 1, characterized in that the second and later levels include an identifier showing their relative locations.

5. Terminal device for downloading a structured file, containing formatted text and other information, from a server to a terminal device, by using software in the device, over a telecommunications link, in which the terminal device includes at least
means for receiving the file from the telecommunications link, as an information flow of a series of characters, the file thus containing consecutive information levels, each with an initial identifier,
a processor and a memory for processing and opening the structured file,
a display for showing information of the structured file,
an application program for processing the information contents of the information levels at following steps:
receiving of the information flow of the structured file while storing the characters received in the memory in a selected area of the memory,
detecting each initial identifier from the information flow, in order to distinguish the information layers from each other and storing the corresponding information in the second selected area of the memory,
processing each stored information level in the memory separately, in such a way that its content is transferred from the memory to the display, according to the application program.

6. Terminal device according to claim 5, characterized in that the application program has processing code for processing at least text and images for displaying and formatting of the text therein.
